(19) United States
(12) Patent Application Publication
(10) Pub. No.: US 2016/0197767 A1
(43) Pub. Date: Jul. 7, 2016

(54) METHOD OF CONTROLLING COMMUNICATION IN LOCOMOTIVE

(71) Applicant: Electro-Motive Diesel, Inc., LaGrange, IL (US)

(72) Inventors: Benjamin A. Raeder, Mt. Prospect, IL (US); Randy C. Marten, Willow Springs, IL (US); Dennis Melas, Chicago, IL (US)

(73) Assignee: Electro-Motive Diesel, Inc., LaGrange, IL (US)

(21) Appl. No.: 15/068,729

(22) Filed: Mar. 14, 2016

(51) Int. Cl. H04L 12/24; H04L 12/26

(52) U.S. Cl. CPC H04L 41/0668; H04L 43/0817

(57) ABSTRACT

A method for controlling communication between an off-board system and a railway wagon is provided. The method includes detecting a failure in communication between a first modem and the off-board system by, a first control unit. The method also includes determining a working mode of a second modem via a second control unit, by the first control unit. The working mode includes at least one of operational and non-operational. The method further includes receiving an identification number of the second modem from the second control unit when the working mode of the second modem is operational. The method includes establishing a communication between the first control unit and the second modem for transmitting the data associated with the first control unit to the off-board system based on the identification number of the second modem.

### TECHNICAL FIELD

The present disclosure relates to a railway wagon, and more particularly to a method of controlling communication between a railway wagon and an off-board system.

### BACKGROUND

Railway wagons are used to carry passengers and goods from one location to another. Generally, a railway wagon is in communication with various off-board systems for exchange of information pertaining to operations of the railway wagon. Such information may include location of the railway wagon, an operating status of the railway wagon, engine speed, and fault in a braking system of the railway wagon. Typically, the off-board systems are used to control operations of the railway wagon based on the information communicated by the railway wagon. Therefore, it is required to maintain a continuous communication between the railway wagons and the off-board systems in order to ensure a smooth operation of the railway wagon. In absence of an effective communication between the railway wagons and the off-board systems, operation of the railway wagon may be adversely affected.

U.S. Patent Publication Number 2013/0261842, hereinafter referred to as '842 publication, describes a method to obtain data relating to operation of a first vehicle in a vehicle consist that includes the first vehicle and a second vehicle. The first vehicle and second vehicle are communicatively coupled with each other by a communication channel. The first vehicle includes a first electronic component performing functions for the first vehicle using the first data. The method also includes communicating the first data over the communication channel from the first vehicle to a second electronic component disposed onboard the second vehicle responsive to the first electronic component being unable to perform the one or more functions for the first vehicle using the first data. The functions of the first electronic component are then performed with the second electronic component using the first data that is received from the first vehicle. However, the '842 publication does not describe a method to avoid data loss associated with the railway wagon and to thereby maintain an uninterrupted communication of the railway wagon with the off-board system.

### SUMMARY OF THE DISCLOSURE

In one aspect of the present disclosure, a method for controlling communication between an off-board system and a railway wagon is provided. The method includes detecting a failure in communication between a first modem and the off-board system by a first control unit. The first modem is in electronic communication with the first control unit and the off-board system for transmitting data associated with the first control unit to the off-board system. The first modem and the first control unit are located in a first locomotive of the railway wagon. The method also includes determining a working mode of a second modem via a second control unit, by the first control unit. The working mode includes at least one of operational and non-operational. The second modem is in communication with the second control unit. The second modem and the second control unit are located in a second locomotive of the railway wagon. The method further includes receiving an identification number of the second modem from the second control unit when the working mode of the second modem is operational. The method includes establishing a communication between the first control unit and the second modem for transmitting the data associated with the first control unit to the off-board system based on the identification number of the second modem.

Other features and aspects of this disclosure will be apparent from the following description and the accompanying drawings.

### BRIEF DESCRIPTION OF THE DRAWINGS

FIG. 1 is a schematic view of a railway wagon in communication with an off-board system, according to the concepts of the present disclosure;

FIG. 2 is a block diagram of a first control unit and a second control unit of the railway wagon of FIG. 1; and

FIG. 3 is a flowchart of a method for controlling communication between the railway wagon and the off-board system.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

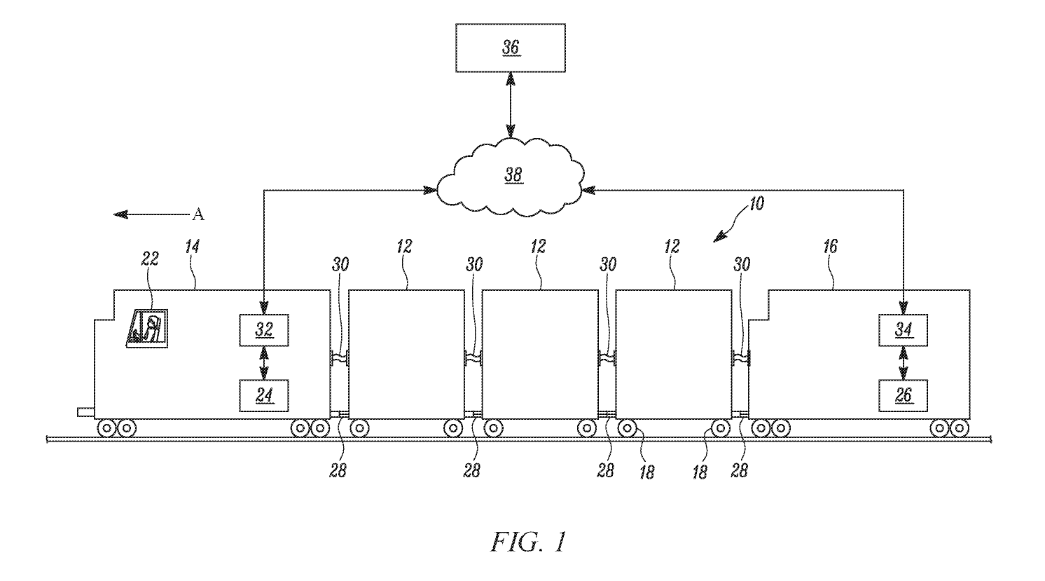

FIG. 1 shows a schematic view of an exemplary railway wagon 10. The railway wagon 10 includes one or more carriage cars 12 coupled one behind the other. Generally, the carriage cars 12 may carry loads or passengers to be moved from one location to another by the railway wagon 10. The exemplary railway wagon shown in FIG. 1 includes a first locomotive 14 and a second locomotive 16. In one example, the first and second locomotives 14, 16 includes a power source, such as an engine (not shown), that generates power to drive the railway wagon 10, so that the first and second locomotives 14, 16 may pull and/or push the carriage cars 12. The engine may be mounted in an engine compartment (not shown) of the first and second locomotives 14, 16. The first and second locomotives 14, 16 may be of any suitable type, known in the art. The railway wagon 10 further includes wheels 18 coupled to the first and second locomotives 14, 16 and the carriage cars 12. The wheels 18 may be disposed to support and move the railway wagon 10 on rails 20.

In an exemplary configuration, as shown in FIG. 1, the first locomotive 14 may pull the carriage cars 12 in a direction of travel “A”. The second locomotive 16 is connected behind the carriage cars 12, with respect to the direction of travel “A”. The second locomotive 16 that is disposed behind the carriage cars 12 may push the carriage cars 12 along the direction of travel “A”. It may be contemplated that the first locomotive 14 and the second locomotive 16 co-operatively drive the railway wagon 10 in the direction of travel “A”. It may be understood that, the railway wagon 10 may be operated with any number of locomotives connected to the carriage cars 12. Each of the carriage cars 12 may be mechanically coupled to each other and to the first and second locomotives 14, 16 through a mechanical coupling unit 28.

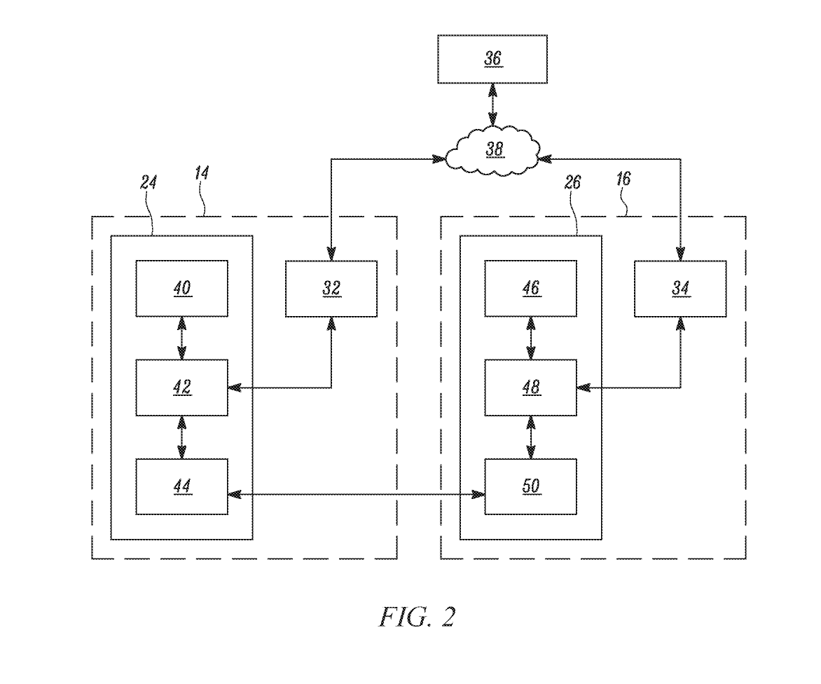

The first locomotive 14 and the second locomotive 16 may include an operator cabin 22. The operator cabin 22 may include various control levers (not shown) and switches (not shown) to control operations of the railway wagon 10. The first and second locomotives 14, 16 include a first control unit 24 and a second control unit 26, respectively. The first and the second control units 24, 26 will be explained in detail later in this section with reference to FIG. 2. The first locomotive 14, the carriage cars 12, and the second locomotive 16 are communicably connected with each other via a multiple unit (MU) cable bus 30 in a master/slave configuration known in the art. It may be understood that the MU cable bus 30 electronically connects the first locomotive 14 with the second locomotive 16 and the carriage cars 12 in the railway wagon 10 to control the second locomotive 16 and the carriage cars 12 from the operator cabin 22 at the first locomotive 14.

The first locomotive 14 includes a first modem 32. Further, the second locomotive 16 includes a second modem 34. The first and second modems 32, 34 enable the railway wagon 10 to communicate with an off-board system 36. The first and the second modems 32, 34 will be explained in detail later in this section with reference to FIG. 2. The off-board system 36 is located remotely with respect to the railway wagon 10. The off-board system 36 receives data related to the railway wagon 10. The data may include an operating status of the railway wagon 10, engine speed, and/or fault in a braking system of the railway wagon 10. The off-board system 36 may control operations of the railway wagon 10 based on the received data. The off-board system 36 may include a number of systems, circuits, and assemblies that aid an operator of the railway wagon 10 to remotely monitor and control the operation of the railway wagon 10.

The railway wagon 10 communicates with the off-board system 36 using a communication network 38. The communication network 38 may be, but is not limited to, a wide area network (WAN), a local area network (LAN), an ethernet, an internet, an intranet, a cellular network, a satellite network, or any other network for transmitting data between the railway wagon 10 and the off-board system 36. In various examples, the communication network 38 may include a combination of two or more of the aforementioned networks and/or other types of networks known in the art. The network may be implemented as a wired network, a wireless network or a combination thereof. Further, the data may be transmitted over the communication network 38 with a network protocol, for example, in an encrypted format, or any other secure format known in the art.

Referring to FIG. 2, a block diagram of the first control unit 24 and the second control unit 26 is illustrated. The first control unit 24 includes a first processing unit 40. The first processing unit 40 may be communicably coupled to multiple sensing units (not shown) that are disposed in the first locomotive 14. The sensing units may sense various operational parameters including, but not limited to, location, engine speed, or information regarding a connection status of the carriage cars 12 with the first locomotive 14. The first processing unit 40 may be connected to the operator cabin 22 for assisting the operator in controlling the operations of the railway wagon 10. In one example, the first processing unit 40 may include a locomotive computer (not shown) and/or a Graphical User Interface (GUI) computer (not shown). Further, the first control unit 24 includes a first switch 42. The first switch 42 is in communication with the first processing unit 40. The first control unit 24 also includes a first trainline network box 44. The first trainline network box 44 is connected to the MU cable bus 30 (see FIG. 1) for enabling the communication between the first locomotive 14, the carriage cars 12, and the second locomotive 16 of the railway wagon 10. In one example, the first switch 42 may include a control logic for regulating communication of the first processing unit 40 with the first modem 32 and the first trainline network box 44.

The second control unit 26 includes a second processing unit 46, a second switch 48, and a second trainline network box 50. It may be contemplated that construction and functionalities of the second processing unit 46, the second switch 48, and the second trainline network box 50 of the second control unit 26 are identical with construction and functionalities of the first processing unit 40, the first switch 42, and the first trainline network box 44 of the first control unit 24. As illustrated in FIG. 2, the first trainline network box 44 of the first control unit 24 is in communication with the second trainline network box 50 of the second control unit 26.

The first modem 32 is in communication with the off-board system 36, via the communication network 38. The first modem 32 modulates data transmitted from the first modem 32 to the off-board system 36. The data transmitted from the first modem 32 may include operational parameters of the first locomotive 14 available at the first processing unit 40. The first modem 32 also demodulates data received from the off-board system 36. The data received from the off-board system 36 may include multiple control instructions for controlling the operations of the railway wagon 10.

It may be understood that constructional and functional features of the second modem 34 are identical to the first modem 32. The second modem 34 is also in communication with the off-board system 36. However, in a normal operating condition of the railway wagon 10, the off-board system 36 principally communicates with the first modem 32. When the railway wagon 10 is in operation, the first processing unit 40 collects the data associated with the railway wagon 10 and processes the data. The first processing unit 40 sends the data to the first modem 32 via the first switch 42. Subsequently, the first modem 32 sends the data to the off-board system 36.

The first processing unit 40 or the first switch 42 is enabled to determine a failure of the first modem 32. Further, the locomotive computer or the GUI computer of the first processing unit 40 may also be enabled to determine the failure of the first modem 32. The failure may occur due to reasons including, but are not limited to, loss of power and loss of connection of the first modem 32 with the off-board system 36. The failure of the first modem 32 may result in transmission of invalid data to the off-board system 36 and/or loss of the data associated with the railway wagon 10. The first processing unit 40 may detect the failure in communication between the first modem 32 and the off-board system 36 based on aforementioned conditions. In one example, the failure in the communication may be detected based on receipt of an invalid network data from the first modem 32. In a situation where the first processing unit 40 detects the failure, the first control unit 24 communicates with the second control unit 26 to determine a working mode of the second modem 34. More particularly, in order to determine the working mode of the second modem 34, the first processing unit 40 communicates with the second processing unit 46. The working mode of the second modem 34 may be operational or non-operational. The first control unit 24 and the second control unit 26 communicate with each other via the first trainline network box 44 and the second trainline network box 50.

When the second processing unit 46 determines the working mode of the second modem 34, the second control unit 26 communicates the working mode of the second modem 34 to the first control unit 24. If the second modem 34 is in the operational working mode, the second processing unit 46 sends an identification number of the second modem 34 to the first processing unit 40 and/or the first switch 42 of the first control unit 24. In one example, the identification number of the second modem 34 may be an Internet Protocol (IP) address, web address, or any other unique communication data of the second modem 34.

Further, the second processing unit 46 initiates a back up mode upon sending the identification number of the second modem 34 to the first control unit 24. During the back up mode, the second processing unit 46 discontinues its communication with the second modem 34 using the second switch 48. The back up mode assists in storing data collected by the second processing unit 46 when the first processing unit 40 is in communication with the second processing unit 46. Once the second processing unit 46 of the second control unit 26 initiates the back up mode, the first switch 42 replaces an identification number of the first modem 32 with the identification number of the second modem 34. This enables the first processing unit 40 to establish a communication with the second modem 34. Upon establishing the communication between the first processing unit 40 and the second modem 34, the second modem 34 initiates a communication with the off-board system 36. Accordingly, the second modem 34 receives the data from the first control unit 24 and transmits the data to the off-board system 36. Further, the second modem 34 receives the control instructions that are sent by the off-board system 36 for controlling the railway wagon 10. Subsequently, the second modem 34 sends the received control instructions to the first processing unit 40 for controlling the operations of the railway wagon 10.

### INDUSTRIAL APPLICABILITY

The present disclosure relates to a method 52 of controlling the communication between the off-board system 36 and the railway wagon 10. The method 52 allows continuous and uninterrupted communication between the railway wagon 10 and the off-board system 36 in order to ensure a smooth operation of the railway wagon 10. In case of failure of the first modem 32, the first control unit 24 disposed in the first locomotive 14 establishes communication with the second modem 34 for maintaining the uninterrupted communication between the railway wagon 10 and the off-board system 36.

Further, the second processing unit 46 located in the second locomotive 16 is enabled to initiate the back up mode. The back up mode assists in storing the data collected by the second processing unit 46 when the first processing unit 40 is in communication with the second processing unit 46. Thus, the back up mode assures that the data pertaining to the second locomotive 16 is not lost when the first processing unit 40 is in communication with the second processing unit 46.

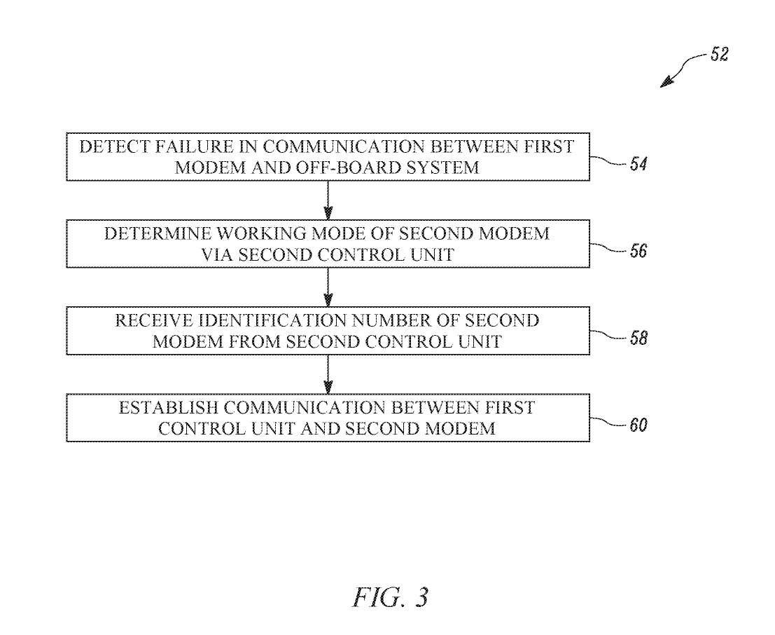

Referring to FIG. 3, a flowchart for the method 52 for controlling communication between the off-board system 36 and the railway wagon 10 is illustrated. The railway wagon 10 includes two locomotives 14, 16. At step 54, the first control unit 24 detects the failure in communication between the first modem 32 and the off-board system 36. The first modem 32 is in electronic communication with the first control unit 24 and the off-board system 36. The first modem 32 transmits the data associated with the first control unit 24 to the off-board system 36. The first modem 32 and the first control unit 24 are located in the first locomotive 14 of the railway wagon 10.

At step 56, the working mode of the second modem 34 is determined by the first control unit 24. The working mode of the first modem 32 may be operational or non-operational. Further, the second modem 34 is in communication with the second control unit 26. The second modem 34 and the second control unit 26 are located in the second locomotive 16 of the railway wagon 10. If the working mode of the modem is operational, the first processing unit 40 receives the identification number of the second modem 34 at step 58. The identification number of the second modem 34 is received from the second control unit 26. At step 60, the communication between the first control unit 24 and the second modem 34 is established for transmitting the data associated with the first control unit 24 to the off-board system 36. The communication between the first control unit 24 and the second modem 34 is established based on the identification number of the second modem 34.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of controlling communication between an off-board system and a railway wagon, the railway wagon having at least two locomotives, the method comprising:
detecting, by a first control unit, a failure in communication between a first modem and the off-board system, the first modem being in electronic communication with the first control unit and the off-board system for transmitting data associated with the first control unit to the off-board system, wherein the first modem and the first control unit are located in a first locomotive of the railway wagon;
determining, by the first control unit, a working mode of a second modem via a second control unit, the working mode being one of operational and non-operational, wherein the second modem is in communication with the second control unit, the second modem and the second control unit are located in a second locomotive of the railway wagon;
receiving, from the second control unit, an identification number of the second modem when the working mode of the second modem is operational; and
establishing a communication between the first control unit and the second modem for transmitting the data associated with the first control unit to the off-board system, wherein the communication between the first control unit and the second modem is established based on the identification number of the second modem.
